(19) United States
(12) Patent Application Publication
(10) Pub. No.: US 2026/0146112 A1
(43) Pub. Date: May 28, 2026

(54) PHOTO-MELT-BULK POLYMERIZATION FOR RECYCLABLE POLYDIENE-DERIVATIVES

(71) Applicant: Purdue Research Foundation, West Lafayette, IN (US)

(72) Inventors: Letian Dou, West Lafayette, IN (US); Qixuan Hu, West Lafayette, IN (US); Pengfei Wu, Lafayette, IN (US)

(73) Assignee: Purdue Research Foundation, West Lafayette, IN (US)

(21) Appl. No.: 19/329,751

(22) Filed: Sep. 16, 2025

Related U.S. Application Data
(60) Provisional application No. 63/696,463, filed on Sep. 19, 2024.

(51) Int. Cl. C08F 136/14; C08F 301/00; C08J 11/12

(52) U.S. Cl. CPC C08F 136/14; C08F 301/00; C08J 11/12; C08J 2353/02

(57) ABSTRACT

Methods of polymerizing a diene to produce a polydiene, the method comprising (i) melting a diene to produce a neat liquid; and (ii) irradiating the melted polydiene with ultraviolet (UV) light to produce a polymer; wherein the melting and irradiating are performed substantially in the absence of solvent or catalyst.

### CROSS REFERENCE TO RELATED APPLICATIONS

This application claims priority to U.S. provisional patent application No. 63/696,463, which was filed Sep. 19, 2024, which is hereby incorporated by reference in their entireties.

### BACKGROUND

Polydienes, particularly 1,3-butadiene derivatives, are indispensable to the chemical industry due to their extensive applications. Traditional polymerization methods for dienes often require numerous additives, necessitating additional purification steps and careful preservation of ionic reagents, catalysts, or initiators. Polydienes synthesized via free radical polymerization often exhibit low molecular weight and varied configurations. Advanced techniques such as living/controlled radical polymerization can mitigate unwanted reactions using sophisticated initiators and end-capping agents, yet they introduce significant costs and complexities associated with additive synthesis and purification. Moreover, these methods often prove ineffective for polydienes due to high termination rates and sensitivity to reaction conditions, resulting in inefficient control over molecular weight and distribution.

Coordination and anionic polymerizations, widely employed in the industry for polydienes synthesis, offer precise control over molecular weight and architecture but require stringent conditions and are highly sensitive to impurities. Alternatively, topochemical polymerization, although providing a clean pathway to near-perfect polymer crystals, faces practical limitations, including the necessity for crystallinity and molecular alignment, the inability to construct flexible architectures such as block copolymers, and poor solubility and processability.

Recycling of polydienes can require high energy and, due to high temperatures required and result in unwanted impurities. This results in high cost and quality issues.

Accordingly, there is a need in the art for improved recyclable polydiene derivatives and methods of production of same.

### SUMMARY

In some aspects, the present disclosure is drawn to methods of polymerizing a diene to produce a polydiene which can include the steps of: (i) melting the diene to produce a melted diene; and (ii) irradiating the melted diene with ultraviolet (UV) light to produce a polymer, wherein the melting and irradiating may be performed substantially in the absence of solvent or catalyst.

In some embodiments, the diene may be a muconate ester. According to examples, the muconate ester may be a C₁-C₁₂ ester. For instance, some muconate esters may be a methyl, ethyl, propyl, or butyl ester.

In certain embodiments, the UV light may be about 315 nm to about 400 nm. In some embodiments, the UV light used to irradiate the melted diene may be provided by a UV lamp having a power of about 1 W to about 1000 W or about 5 W to about 500 W or about 10 W to about 100 W.

In some embodiments, the melting and irradiating steps may be performed in the absence of a solvent. In other embodiments, the melting and irradiating may be performed in the absence of a catalyst. In yet other embodiments, the melting and irradiating may be performed in the absence of both solvent and catalyst.

According to other aspects, the disclosure concerns methods of producing a polydiene via photo-melt-bulk polymerization (PMBP), which can include the steps of: (i) reacting muconic acid with a compound of the formula R—OH to form a dialkyl muconate, wherein R is C₁-C₁₂ alkyl; (ii) melting the dialkyl muconate to produce a neat liquid; and (iii) irradiating the melted dialkyl muconate with ultraviolet (UV) light to produce a polymer. In examples, the melting (ii) and irradiating (iii) steps may be performed substantially in the absence of solvent or catalyst. In the same or other examples, R may be C₁-C₁₂ alkyl. For instance, R may be methyl, ethyl, propyl, or butyl. In the same or yet other examples, the muconic acid may be a trans-trans muconic acid or a trans-cis muconic acid. In a number of the foregoing examples, the reacting step (i) may be performed in the presence of sulfuric acid.

Other aspects of the disclosure concern methods of producing a polymer according to the steps of: (i) reacting muconic acid with a compound of the formula R—OH to form a dialkyl muconate, wherein R is C₁-C₁₂ alkyl; (ii) melting the dialkyl muconate to produce a neat liquid; (iii) irradiating the melted dialkyl muconate with ultraviolet (UV) light to produce a polymer; and (iv) mixing styrene into the polymer in the absence of UV light to produce a triblock copolymer. In examples, the melting (ii) and irradiating (iii) steps may be performed substantially in the absence of solvent or catalyst. In the same or other examples, R may be C₁-C₁₂ alkyl. For instance, R may be methyl, ethyl, propyl, or butyl. In the same or yet other examples, the muconic acid may be a trans-trans muconic acid or a trans-cis muconic acid. In one or more of the foregoing examples, the reacting step (i) may be performed in the presence of sulfuric acid. In one or more of the foregoing examples, acrylonitrile may be added with the styrene in the turning off step (iv).

Yet other aspects of the disclosure concern methods of depolymerizing a polymer made by the methods disclosed herein, the depolymerizing method comprising heating the polymer to a temperature from about 230° C. to about 340° C.

### BRIEF DESCRIPTION OF THE DRAWINGS

FIG. 1. presents a schematic representation of polymerization methods for polydienes. FIG. 1A and FIG. 1B show diene-based polymer production from the art. FIG. 1C illustrates an example photo-melt-bulk polymerization (PMBP) method of the disclosure for the preparation of amorphous PMEs, triggered by UV light in the melt state. The biradical mechanism enables nearly unterminated propagation, even when chain coupling occurs. FIG. 1D shows six side groups (R in the chemical structure) that may be available for PMBP based on their mild melt points. FIG. 1E shows digital photographs of the PMBP procedure, demonstrating the transition from solid monomer (left) to melt state (middle) to final polymer crude (right) after 36 hours, without the use of catalysts, initiators, or solvents.

FIG. 2 shows polymerization kinetics and mechanism investigations. FIG. 2A provides a first-order plot of polymerization time using a 10 W lamp, showing linear kinetics with an apparent propagation rate of 0.006 h⁻¹. FIG. 2B plots the conversion to polymer versus Mn and dispersity (D, Mw/Mn), indicating a gradually narrowed dispersity that eventually becomes smaller than 2. FIG. 2C plots the conversion versus time from an experiment of temporal control using a pulsed irradiation sequence under varied thermal conditions. The temperature varies from the second step, with the first step proceeding at 100° C. FIG. 2D shows SEC profiles of PME-Et homopolymers with scaled-up polymerization via PMBP under various conditions, detailed in Table 5 [HPLC-CHCl₃, 35° C.]. The values inset are the relative molecular weight and dispersity. FIG. 2E provides ¹³C NMR spectra of PME-Et homopolymers from PBMP and FRP [CDCl₃, R.T. (800 Hz)]. Insets show the zoomed regions distinguishing 1,4-addition (˜171 ppm) and 1,2-addition (˜165 ppm), as well as trans configuration (˜51 ppm) and cis configuration (˜46 ppm) of polymers from PMBP (black) and FRP (red). Integration analysis indicates that PME-Et from FRP contains approximately 2% of 1,2-addition, 11% of cis, and 87% of trans, while almost no 1,2-addition (<0.5%) and 6% of cis configuration may be detected for PMBP. FIG. 2F provides EPR spectra of crude PME-Et (after 20 hours of PMBP with a 20 W lamp) stored in the dark at room temperature for 10 days, and 92.1% of radical remaining after 10 days. FIG. 2G provides density functional theory (DFT) calculations of molecular orbitals at singlet and triplet ground state and singlet first excited state along with analogous Lewis structures and relevant spin densities for predicting radical bias positions. FIG. 2H provides an Intrinsic Reaction Coordinate (IRC) plot in terms of the C₃-C₄ bond length comparing the transition state of the thermal mechanism (blue graph and dots) and labeled important structures (black dots) with that of the photo-excitation mechanism (green star). The change in free energy values is relative to that of the starting structure of the thermal pathway.

FIG. 3A and FIG. 3B present a plot of conversion versus polymerization time for PME-Et homopolymers from different pots using two different UV lamp powers (10 W in square and 20 W in round), as detailed in Tables 1 and 2, herein.

FIG. 4 shows mechanical properties (tensile stress test) of PME-Et with different molecular weights obtained from PMBP methods, indicating a positive influence of molecular weight on the mechanical properties.

FIG. 5 presents a demonstration of block and random copolymerization via the PMBP method and applications for TPEs and ABS-like plastics. FIG. 5A is a schematic showing the PMBP method for the preparation of copolymers with various topological structures. Left: Triblock copolymers for TPE applications were prepared under UV-off conditions after adding styrene. Right: Random tri-copolymer for ABS-like plastics was prepared under constant UV irradiation after adding co-monomers. FIG. 5B shows SEC traces of block copolymerization of ME-Et (top) and ME-Pr (bottom) with styrene, both showing a significant shift to higher molecular weight regions. FIG. 5C presents 2D and 3D phase retrace AFM images of block copolymers: SM(Et)S (top) and SM(Pr)S (bottom), indicating phase separation caused by block segments of PS. FIG. 5D presents tensile stress-strain curves of SM(Et)S and PME-Et. The inset blue region highlights the tensile performance of commercial SBS TPE. FIG. 5E shows SEC traces for the stability test of ABS-like plastic stored under harsh conditions (Mn-373 kDa, PDI-2.28). FIG. 5F presents tensile stress-strain curves of synthesized ABS-like plastic compared with commercial ABS. FIG. 5G provides digital photographs of Lego® and toys made from ABS-like plastic.

FIG. 6. shows chemical depolymerization of PMEs-based polymers. FIG. 6A presents a demonstration of closed-loop recycling of PME-Et with a feed amount of 4 g, depolymerized in DPE, recovering 79% of ME-Et, which is further polymerizable. FIG. 6B presents ¹H NMR spectra of original ME-Et, PME-Et, recycled ME-Et (R-ME-Et), and repolymerized PME-Et (R-PME-Et) from the recycled monomer using the PMBP method. FIG. 6C illustrates chemical depolymerization of TPEs (SM(Et)S as an example) in DPE, recovering 86% of ME-Et and retaining PS segments. FIG. 6D shows depolymerization of synthesized ABS-like plastic under vacuum in the presence of ZnO and NaCl, successfully recycling all three monomers in certain yields. FIG. 6E presents ¹H NMR of recycled ME-Et (top) and liquid collection containing styrene (*), acrylonitrile (#), toluene (\hat{ }), and ethanol.

FIG. 7 illustrates dilute solution depolymerization of PMEs under Argon at 250° C. for 60 min, and the error bar is according to the depolymerization yields from 3 times of reaction. Detail are 92%, 91%, and 86% for PME-Bu; 97%, 93%, and 88% for ME-Pr; 96%, 94%, and 87% for PME-Et; 86%, 84%, and 79% for PME-Me; 90%, 84%, and 83% for PME-B; 79%, 76%, and 75% for PME-BOMe.

### DETAILED DESCRIPTION

Since the advent of polymer science, numerous polymerization methods have been developed, with most commercial polymers currently produced via gas-phase or solution-phase processes involving sophisticated initiators, catalysts, and additives. Here, a novel ultra-clean photo-melt-bulk polymerization (PMBP) strategy for the controllable synthesis of high molecular weight polydienes is provided herein, eliminating the need for solvents, catalysts, and/or initiators. The presently disclosed methods employ UV irradiation to generate long-lived biradicals in muconate derivatives that enable precise chain propagation without termination. This approach also facilitates the straightforward synthesis of ABA tri-block copolymers and efficient random copolymerization. Significantly, due to their inherently weakened carbon-carbon bonds, these polymers and copolymers may be readily depolymerized to their monomeric forms with high yields, promoting efficient chemical recycling.

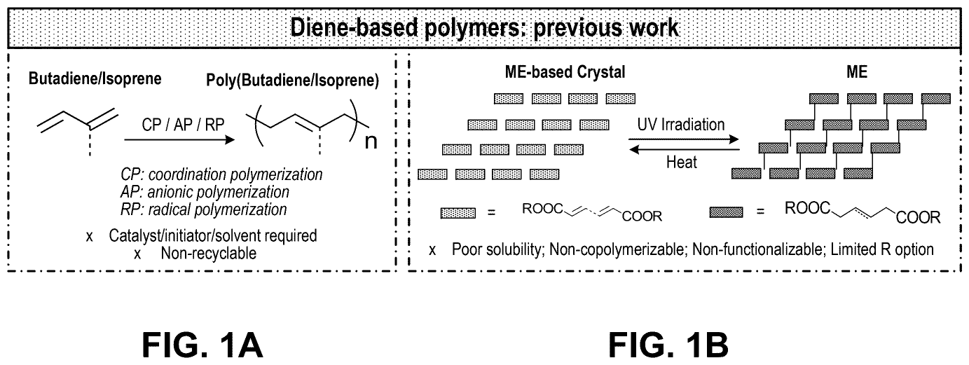

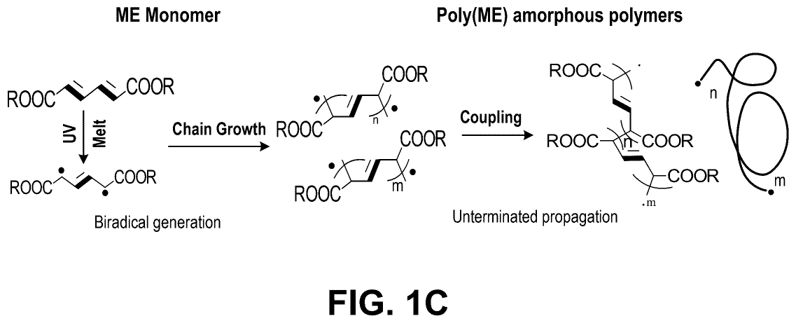

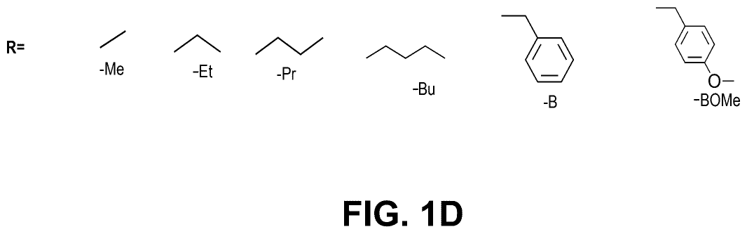

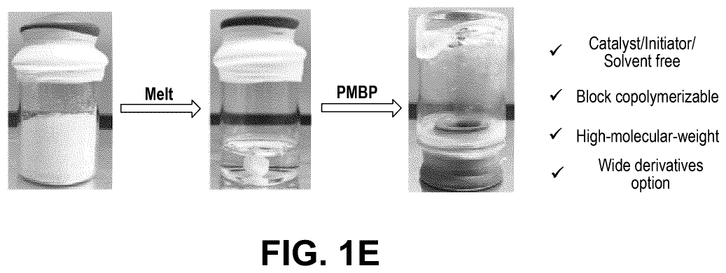

An ultra-clean photo-melt-bulk polymerization (PMBP) method is disclosed for synthesizing amorphous and processable polymuconate esters (PMEs), a type of bio-sourced polydienes (A. Matsumoto, Macromolecules 29, 423-432 (1996); C. Ling, Nature Communications 2022 13:1 13, 1-14 (2022); D. Maniar, Polymers 13, 2498 (2021); N. A. Rorrer, ACS Sustain Chem Eng 4, 6867-6876 (2016); and G. Quintens, Polym Chem 10, 5555-5563 (2019), each of which is incorporated herein by reference), without the need of solvents, catalysts, or initiators as shown in FIG. 1C-FIG. 1E. FIG. 1C shown use of UV light to product a ME radical. FIG. 1D depicts chain growth during polymerization. FIG. 1E illustrates some R groups that can be utilized. Utilizing UV irradiation, the instant approach generates long-lived biradicals that enable stable chain propagation with minimum chain termination probabilities, ensuring controlled growth and high molecular weights with negligible configuration defects such as 1,2-addition. The instant methods exhibit linear chain growth kinetics with a direct correlation between molecular weight and conversion, highlighting its controllable nature. Furthermore, PMBP facilitates the straightforward synthesis of complex polymer architectures such as ABA tri-block copolymers, ABS (Acrylonitrile-Butadiene-Styrene)-like plastic and facilitates efficient depolymerization and recycling.

In some aspects, the disclosure concerns methods of polymerizing a diene to produce a polydiene, which may include the steps of: (i) melting the diene to produce a melted diene; and (ii) irradiating the melted diene with ultraviolet (UV) light to produce a polymer, wherein the melting and irradiating may be performed substantially in the absence of solvent or catalyst.

In some embodiments, the diene may be a muconate ester. In certain embodiments, the muconate ester is a C₁-C₁₂ ester. By way of example, some muconate esters may be a methyl, ethyl, propyl, or butyl ester. Certain esters may be branched or aromatic. Examples of such muconate esters include:

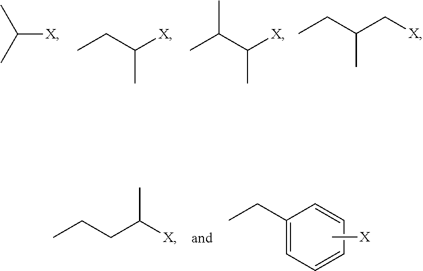

muconate esters, where X is H, F, Cl, Br, I, or CH₃ and the point of attachment to the muconate group is a terminal methyl group.

In certain embodiments, the UV light is about 315 nm to about 400 nm or about 320 nm to about 380 nm or about 325 nm to about 365 nm or about 330 nm to about 370 nm. In some embodiments, the UV light used to irradiate the melted polydiene may be provided by a UV lamp having a power of about 1 W to about 1000 W or about 5 W to about 500 W or about 10 W to about 100 W.

In some embodiments, the melting and irradiating may be performed in the absence of solvent. In other embodiments, the melting and irradiating may be performed in the absence of catalyst. In yet other embodiments, the melting and irradiating may be performed in the absence of solvent and catalyst.

In some embodiments, about 1% to about 10% of a suitable solvent may be utilized with the remainder being the monomers to be polymerized.

According to another aspects, the disclosure concerns methods of producing polydiene via photo-melt-bulk polymerization (PMBP), which can include the steps of: (i) reacting muconic acid with a compound of the formula R—OH to form a dialkyl muconate, wherein R is C₁-C₁₂ alkyl or C₁-C₈ alkyl or C₁-C₄ alkyl; (ii) melting the dialkyl muconate to produce a neat liquid; and (iii) irradiating the melted dialkyl muconate with ultraviolet (UV) light to produce a polymer. In examples, the melting (ii) and irradiating (iii) may be performed substantially in the absence of solvent or catalyst. R may be C₁-C₁₂ alkyl. In certain embodiments, R is methyl, ethyl, propyl, or butyl. The muconic acid may be a trans-trans muconic acid or a trans-cis muconic acid.

In a number of the foregoing example, the reacting (i) may be performed in the presence of sulfuric acid.

Further aspects of the disclosure concern methods of producing a polymer comprising: (i) reacting muconic acid with a compound of the formula R—OH to form a dialkyl muconate, wherein R is C₁-C₈ alkyl or C₁-C₈ alkyl or C₁-C₄ alkyl; (ii) melting the dialkyl muconate to produce a neat liquid; (iii) irradiating the melted dialkyl muconate with ultraviolet (UV) light to produce a polymer; and (iv) turning off the UV light and mixing styrene into the polymer to produce a triblock copolymer. In examples, the melting (ii) and irradiating (iii) may be performed substantially in the absence of solvent or catalyst. In the same or other examples, R may be C₁-C₁₂ alkyl. For instance, R may be methyl, ethyl, propyl, or butyl. In the same or yet other examples, the muconic acid may be a trans-trans muconic acid or a trans-cis muconic acid. In one or more of the foregoing examples, the reacting (i) may be performed in the presence of sulfuric acid. In one or more of the foregoing examples. acrylonitrile may be added with the styrene in the turning off step (iv).

Yet other aspects of the disclosure concern methods of depolymerizing a polymer made by the methods disclosed herein, the depolymerizing method comprising heating the polymer to a temperature of from about 230° C. to about 340° C.

### EXPERIMENTAL

The disclosure is illustrated by the following nonlimiting examples.

### Materials and Methods Used in the Examples

All polymerizations were carried out in flamed standard Schlenk-type glassware on a dual-manifold Schlenk line. All the synthesized ME-based (muconate ester) monomers were purified by recrystallization before used for polymerization. Liquid commercial monomers such as styrene and acrylonitrile were purchased from Sigma and distilled under vacuum to remove the inhibitor, then stored in fridge after purging with ultrahigh purity grade argon for 30 min. other solvents for purification (DCM, EtOAc, hexanes, MeOH, EtOH, 1-propanol, n-butanol, and Chloroform) were used as received. All other chemicals and reagents, except for tans-cis muconate acid (NIRL), were purchased from Sigma or TCI Chemicals without further purification.

### Materials

Trans-trans-Muconic acid (Sigma, 98%), concentrated sulfuric acid (Sigma, 95-98%), 1-(chloromethyl)-4-(methoxymethyl) benzene (Sigma, 98%), Benzyl Chloride (TCI Chemicals, >99%), n-propyl alcohol (TCI, >99.5%), n-butyl alcohol (Sigma, >99.5%), potassium carbonate (Sigma, 98%) was used as purchased. Azobisisobutyronitrile (AIBN, Sigma, 98%) was purified by recrystallisation before use. All solvents like Methanol, ethanol, dichloromethane, chloroform, hexanes are purchased from Fisher and used without further purification.

### Characterization Methods

¹H and ¹³C NMR: Spectra were recorded on a Bruker ARX 400 spectrometer (400/500 MHz for ¹H measurement) and a Bruker ARX 400 spectrometer (800 MHz for 13C measurement). Chemical shifts were referenced to the residual solvent in the deuterated chloroform.

Size-exclusion chromatography (SEC): Measurements were carried out using a chromatographic system consisting of a Hewlett-Packard 1260 Infinity series having a Hewlett-Packard G1362A refractive index (RI) detector and three PL gel 5 m MIXED-C columns. Polystyrene standards (Agilent Easi Cal) were used for the calibrating of molecular weight values. Chloroform was used as mobile phase at temperature of 35° C. and flowing at a rate of 1 mL/min.

Differential scanning calorimetry (DSC): Measurements of the samples were recorded with a Perkin Elmer Jade DSC series instrument under a nitrogen atmosphere. The dry samples were placed in an aluminum pan for the measurement with a weight range of 6-11 mg. for the melting point analysis, monomers were heated from −40 to 100 or 150° C. at a rate of 10° C./min and then recycled for another scan with same procedure. For glass transition temperature (Tg) of polymers, they were heated from −40 or −20 to 140° C. at a rate of 10° C./min. All these values were recorded from the second heating ramp using standard analysis. The depolymerization temperatures of PME-Et and ABS-like were recorded from the first heating ramp from 230 to 260 or 340° C. with a heating rate of 0.5° C./min to offer enough time for depolymerization.

Thermogravimetric analysis (TGA): Thermal stability was analyzed through a TA instruments SDT Q600 analyzer. It was performed on ME-Et based polymers from 50 to 550° C. at a heating rate of 20° C./min under nitrogen gas.

Electron paramagnetic resonance (EPR): Radical concentration change of PMBP periods was completed using a Bruker EMX-EPR spectrometer. In solid EPR experiments, the ME-Et monomer was filled into a standard EPR tube and sealed after changing the atmosphere three times to Argon. The sealed tube with monomers was placed in the oil bath at 100° C. and irradiated by a 10 W UV lamp which is the standard PMBP procedure. All the EPR data were collected at room temperature after polymerized for a certain time. The relative radical concentration was gained from the integration of real EPR spectra.

Uniaxial tensile elongation tests: Uniaxial extension experiments were performed on DMET MTESTQuattro Universal Testing Machine with a fixture moving speed of 0.1 mm/s for plastic-like polymers and 1 mm/s for viscoelastic polymers. Mechanical test dog-bone shape bars were made with aluminum mold meeting ASTM standard D638 type IV. The extrusion of the polymers was conducted with a Xplore MC 5 Micro Compounder with a 5 ml batch volume and 1.75 mm extruder. 3-D printing was conducted using Zmorph Fab 3-D printer with a printing temperature of 120° C.

Film preparation: 1) For AFM; The procedure is described for the films of TPEs. The polymer (0.5 mg) was dissolved in CHCl3 (0.5 mL). An aliquot (ca. 0.05 mL) of the solution was dropped onto a 1-mm glass plate (1 cm×1 cm×1 mm) and spin coated by a spin coater with speed of 3000 rpm/min under air at r.t.; 2) For GIWAX; The procedure is described for the films of TPEs. The polymer (5 mg) was dissolved in CHCl3 (0.5 mL). An aliquot (ca. 0.05 mL) of the solution was dropped onto a 1-mm glass plate (1 cm×1 cm×1 mm) and spin coated by a spin coater with speed of 3000 rpm/min under air at room temperature (r.t.).

Polymer dyeing and molding: ABS-like plastics were dissolved in chloroform and mixed with commercially available epoxy resin dyes under string, then poured into silica molds slowly with different shapes. The filled molds were dried in a vacuum oven at 50° C. for one day.

Density Functional Theory: All energy calculations were performed in Gaussian16 using the wB97X-D3 functional and the DEF2-TZVP basis set. Native geometry optimization was utilized on all structures. Molecular orbital visualizations were obtained from single point calculations using the ORCA quantum chemistry package and rendered using the IBOView quantum chemistry package. These were verified using TDDFT in Gaussian16. The model compounds, based off an unsubstituted monomer, were selected due to their ability to perform the same polymerization chemistry as their substituted analogs while minimizing the necessary DFT computational cost. The IRC was calculated using Yet Another Reaction Program (YARP) to discover, converge, and analyze the transition state and reaction pathway.

### Monomer Synthesis

Monomers were synthesized according to former research with modification (T. Tanaka, J Am Chem Soc 124, 9676-9677 (2002) and R. Lu, Angewandte Chemie International Edition 55, 249-253 (2016), each of which is incorporated herein by reference).

### Trans,Cis-Dimethyl Muconate (ME-Me)

30 g of trans,cis-muconic acid (0.21 mol) was suspended in a large excess of MeOH. 3 mL of concentrated sulfuric acid were added as catalyst and the mixture was refluxed at 70° C. until a homogenous solution was obtained. Hereafter, the reaction crude solution was poured into a large excess of water and residues were filtered out and dried. The almost dried products were separated by going through a flash silica gel column with DCM as eluent to remove the unreacted reactants and monosubstituted product. Then DCM was removed by vacuum evaporator from the DCM phase gained from column to get residues with slight yellow. The residue was recrystallized from MeOH and water to give pure ME-Me crystals. After filtration and drying, 34.5 g ME-Me (0.188 mol) was obtained as an off-white solid with 89.5% yield. ¹H NMR (CDCl₃): δ 8.39 (m, ¹H), 6.64 (t, ¹H), 6.13 (d, ¹H), 5.96 (d, ¹H), 3.78 (s, 3H).

### Trans,Trans-Diethyl Muconate (ME-Et)

30 g of trans,trans-muconic acid (0.21 mol) was suspended in a large excess of EtOH. 3 mL of concentrated sulfuric acid were added as catalyst and the mixture was refluxed at 90° C. until a homogenous solution was obtained. Hereafter, the reaction crude solution was poured into a large excess of water and residues were filtered out and dried. The almost dried products were separated by going through a flash silica gel column with DCM as eluent to remove the unreacted reactants and monosubstituted product. Then DCM was removed by vacuum evaporator from the DCM phase gained from column to get residues with slight yellow. The residue was recrystallized from EtOH and water to give pure ME-Et crystals. After filtration and drying, 36.1 g ME-Et (0.181 mol) was obtained as an off-white solid with 86.1% yield. ¹H NMR (CDCl₃): δ 7.30 (m, 2H), 6.22 (m, 2H), 4.14 (q, 4H), 1.22 (t, 6H).

### Trans,Trans-Dipropyl Muconate (ME-Pr)

30 g of trans,trans-muconic acid (0.21 mol) was suspended in a large excess of 1-propanol. 3 mL of concentrated sulfuric acid were added as catalyst and the mixture was refluxed at 105° C. until a homogenous solution was obtained. Hereafter, the reaction crude solution was poured into a large excess of water and residues were filtered out and dried. The almost dried products were separated by going through a flash silica gel column with DCM as eluent to remove the unreacted reactants and monosubstituted product. Then DCM was removed by vacuum evaporator from the DCM phase gained from column to get residues with slight yellow. The residue was recrystallized from EtOH and water to give pure ME-Pr crystals. After filtration and drying, 43.6 g ME-Pr (0.182 mol) was obtained as an off-white solid with 86.9% yield. ¹H NMR (CDCl₃): δ 7.30 (m, 2H), 6.22 (m, 2H), 4.14 (t, 4H), 1.70 (m, 4H), 0.98 (t, 6H).

### Trans,Trans-Dibutyl Muconate (ME-Bu)

30 g of trans,trans-muconic acid (0.21 mol) was suspended in a large excess of 1-propanol. 3 mL of concentrated sulfuric acid were added as catalyst and the mixture was refluxed at 105° C. until a homogenous solution was obtained. Hereafter, the reaction crude solution was poured into a large excess of water and residues were filtered out and dried. The almost dried products were separated by going through a flash silica gel column with DCM as eluent to remove the unreacted reactants and monosubstituted product. Then DCM was removed by vacuum evaporator from the DCM phase gained from column to get residues with slight yellow. The residue was recrystallized from EtOH and water to give pure ME-Bu crystals. After filtration and drying, 48.2 g ME-Bu (0.189 mol) was obtained as an off-white solid with 89.9% yield. ¹H NMR (CDCl₃): δ 7.30 (m, 2H), 6.22 (m, 2H), 4.17 (t, 4H), 1.66 (m, 4H), 1.40 (m, 4H), 0.98 (t, 6H).

### Trans,Trans-Dibenzyl Muconate (ME-B)

10 g of trans,trans-muconic acid (0.07 mol), 21.4 g of K₂CO₃ (0.155 mol) was suspended in 20 mL of DCM. 22.24 g of benzyl chloride (0.155 mol) were added, and the mixture was stirred at room temperature for 3 days until a homogenous solution was obtained. The reaction crudes were separated by going through a flash silica gel column with DCM as eluent to remove the unreacted reactants and monosubstituted product. Then DCM was removed by vacuum evaporator from the DCM phase gained from column to get residues with slight yellow. The residue was recrystallized from MeOH and DCM to give pure ME-B crystals. After filtration and drying, 18.6 g ME-B (0.055 mol) was obtained as an off-white solid with 79.1% yield. ¹H NMR (CDCl3): δ 7.30-7.39 (m, 12H), 6.23 (m, 2H), 5.21 (s, 4H).

### Trans,Trans-Di Methoxybenzyl Muconate (ME-BOMe)

10 g of trans,trans-muconic acid (0.07 mol), 21.4 g of K₂CO₃ (0.155 mol) was suspended in 20 mL of DCM. 24.27 g of 4-methoxybenzyl chloride (0.155 mol) were added, and the mixture was stirred at room temperature for 3 days until a homogenous solution was obtained. The reaction crudes were separated by going through a flash silica gel column with DCM as eluent to remove the unreacted reactants and monosubstituted product. Then DCM was removed by vacuum evaporator from the DCM phase gained from column to get residues with slight yellow. The residue was recrystallized from MeOH and DCM to give pure ME-BOMe crystals. After filtration and drying, 22.6 g ME-BOMe (0.057 mol) was obtained as an off-white solid with 81.4% yield. ¹H NMR (CDCl₃): δ 7.27-7.35 (m, 6H), 6.89 (d, 4H), 6.20 (m, 2H), 5.14 (s, 4H), 3.81 (s, 6H).

### Bulk Polymerization

### Example 1—Photo-Melt-Bulk Polymerization

The success in UV-induced polymerization of ME derivatives in crystalline states at near room temperature (topochemical polymerization) suggests the diene core can indeed be photo-excited, and the photo-excited monomers can react with each other before they decay to ground state, thanks to the proximity of the monomer molecules in the crystalline state. Inspired by these observations, it is hypothesized that photo-polymerization can also be achieved in a bulk melt if the excited biradical states are sufficiently long-lived in the neat liquid state. With reference to FIG. 1, key distinctions between photo-polymerization and conventional free radical polymerization (FRP) or coordination polymerization of dienes are that the chain growth is always bi-directional and the chain-chain coupling will not lead to a dead chain, as shown in FIG. 1C, which in principle should lead to better control over molecular weight and dispersity (M. Buback, Macromol Chem Phys 198, 1455-1480 (1997) and C. H. Bamford, Polymer (Guildf) 10, 885-899 (1969), each of which is incorporated herein by reference). Meanwhile, because of the larger intermolecular distance in the liquid state, it is believed that certain kinetic energy (heating) is needed to increase the probability of two photo-excited monomers colliding to form a new carbon-carbon bond. However, it is unknown if higher temperature will lead to shorter lifetime of the excited states and therefore quench the reaction. To test these hypotheses, the polymerization of a series of muconate monomers with suitable melting features under UV irradiation with mild heating was examined in FIG. 1D. Side chain functional groups included methyl [Me], ethyl [Et], propyl [Pr], butyl [Bu], benzyl [B], and methoxybenzyl [BOMe]). Encouragingly, the PMBP reaction works extremely well for all cases. For example, FIG. 1E shows the example of ME-Et monomers at room temperature as powder (left), heated at 100° C. as liquid (middle), and polymerized after irradiated with a 10 W Ultraviolet A (UV-A) lamp (315-400 nm) for 36 hours (right).

### Example 2—Photo-Melt-Bulk Polymerization of ME-Et

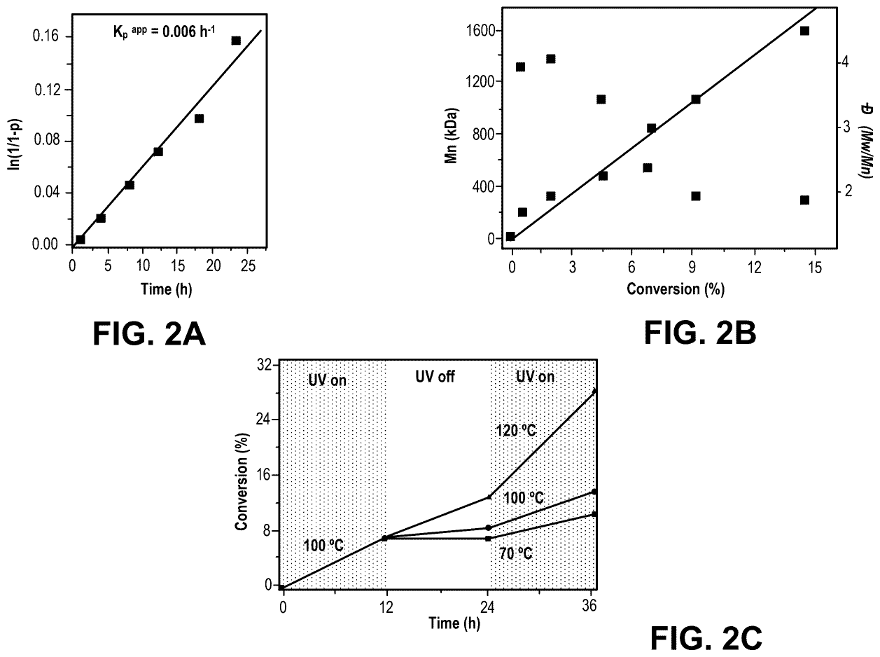

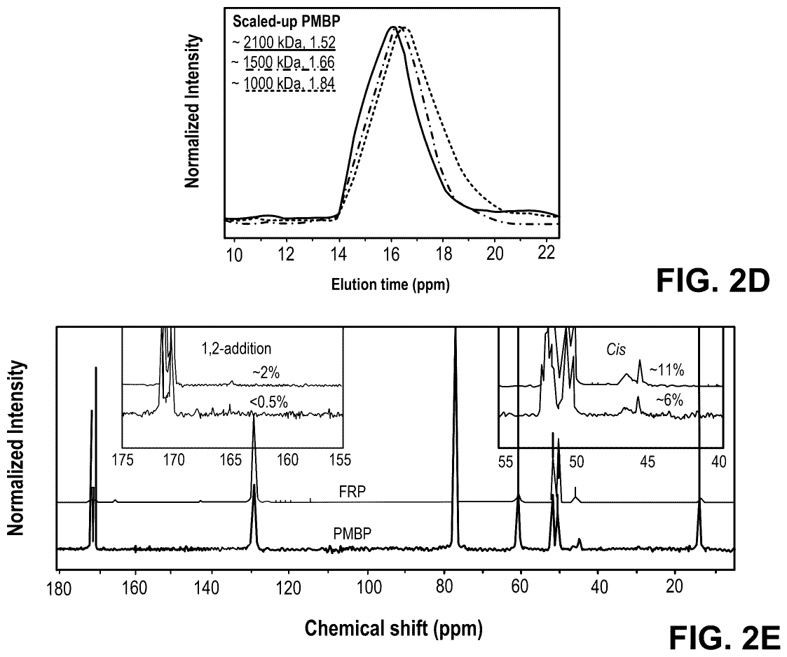

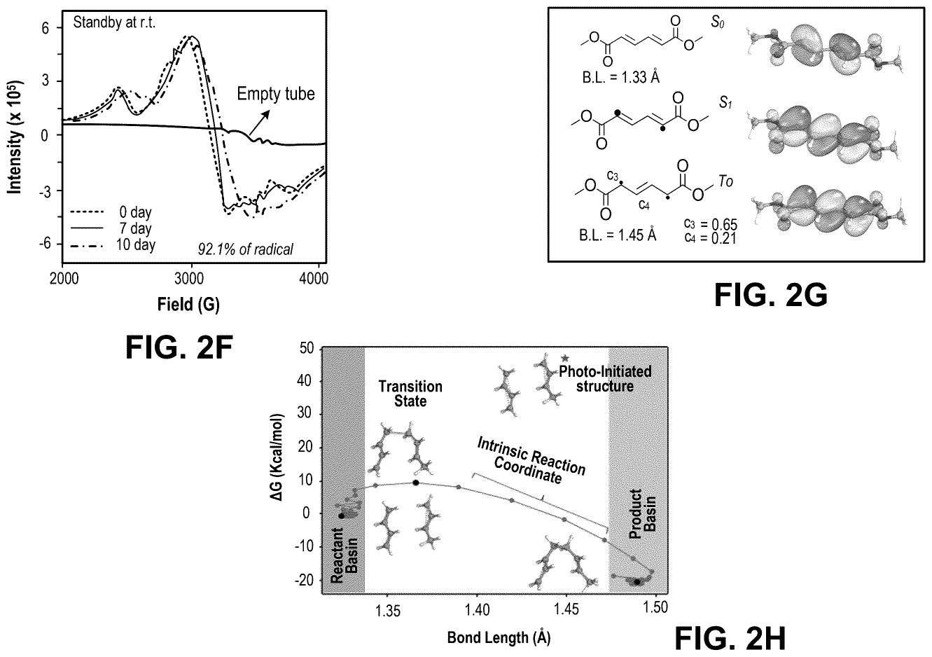

Next, the polymerization kinetics were carefully studied, and a plausible reaction mechanism is proposed. Experimental first-order kinetics of ME-Et polymerization was monitored via proton nuclear magnetic resonance (1H NMR) spectroscopy at 100° C. using the 10 W UV-A lamp. To ensure accuracy without disturbing the ongoing reactions, separate samples were utilized for each reaction time (M. N. Antonopoulou, Nature Synthesis 3, 347-356 (2024)), with details provided in Table 1. In FIG. 2, linear progression was observed over a 24-hour kinetic study, with a polymerization rate constant (kpapp) of 0.006 h−1. After one hour, the PMBP process yields PME-Et with a molecular weight of approximately 200 kDa and a conversion of 0.56%, indicating a rapid initiation chain growth with low monomer conversion. In FIG. 2B, the polydispersity index at 1 hour is notably high, as measured by size-exclusion chromatography (SEC), likely due to the constant radical generation and the formation of polymer chains with various lengths initially. Notably, all SEC curves exhibit a singlet peak that gradually shifts to higher molecular weight regions with increasing time and monomer conversion. Intriguingly, it was observed that a progressive narrowing of dispersity (D) to less than 2 as polymerization advanced, as illustrated in FIG. 2B, with no detectable oligomers in the polymerization crude or its hexane-soluble fraction. This suggests that the continuously generated highly reactive biradical species (e.g., dimers, trimers, oligomers), initially capable of initiating new chains, increasingly couple with existing polymer chains as the reaction proceeds. This preferential coupling extends existing chains rather than forming new ones, leading to a more uniform chain length and lower dispersity. The absence of oligomers indicates efficient incorporation into growing chains, highlighting a controlled polymerization process that produces polymers with consistent and predictable properties.

Table 1 presents details of PMBP of ME-Et with a feed amount of 1 g for different reaction times, from separate reaction pots at 100° C., used in the kinetic study. The UV lamp power was 10 W.

TABLE 1

| | | | | Mₙ | | | |
|---|---|---|---|---|---|---|---|
| Run | Time (h) | Conv. (%)^{a} | Average | (kDa)^{b} | Average | Ð^{b} | Average |
| 1 | 1 h | 0.4 | 0.56 | 120 | 178 | 4.0 | 3.90 |
| 2 | 1 h | 0.6 | | 202 | | 3.9 | |
| 3 | 1 h | 0.7 | | 212 | | 3.8 | |
| 4 | 4 h | 2.0 | 2.0 | 298 | 286 | 4.01 | 4.01 |
| 5 | 4 h | 2.3 | | 303 | | 4.03 | |
| 6 | 4 h | 1.7 | | 257 | | 3.99 | |
| 7 | 8 h | 5.1 | 4.67 | 526 | 503 | 3.24 | 3.40 |
| 8 | 8 h | 4.6 | | 538 | | 3.12 | |
| 9 | 8 h | 4.3 | | 446 | | 3.84 | |
| 10 | 12 h | 6.8 | 6.93 | 797 | 809 | 2.32 | 2.35 |
| 11 | 12 h | 7.6 | | 902 | | 2.18 | |
| 12 | 12 h | 6.4 | | 728 | | 2.56 | |
| 13 | 18 h | 9.4 | 9.30 | 1085 | 1090 | 2.01 | 1.96 |
| 14 | 18 h | 9.6 | | 1121 | | 1.95 | |
| 15 | 18 h | 8.9 | | 1063 | | 1.92 | |
| 16 | 24 h | 14.6 | 14.63 | 1602 | 1619 | 1.84 | 1.84 |
| 17 | 24 h | 14.7 | | 1702 | | 1.76 | |
| 18 | 24 h | 14.6 | | 1554 | | 1.91 | |

^{a}Determined using the NMR spectra [500 Hz, r.t.];
^{b}Determined using the SEC date.

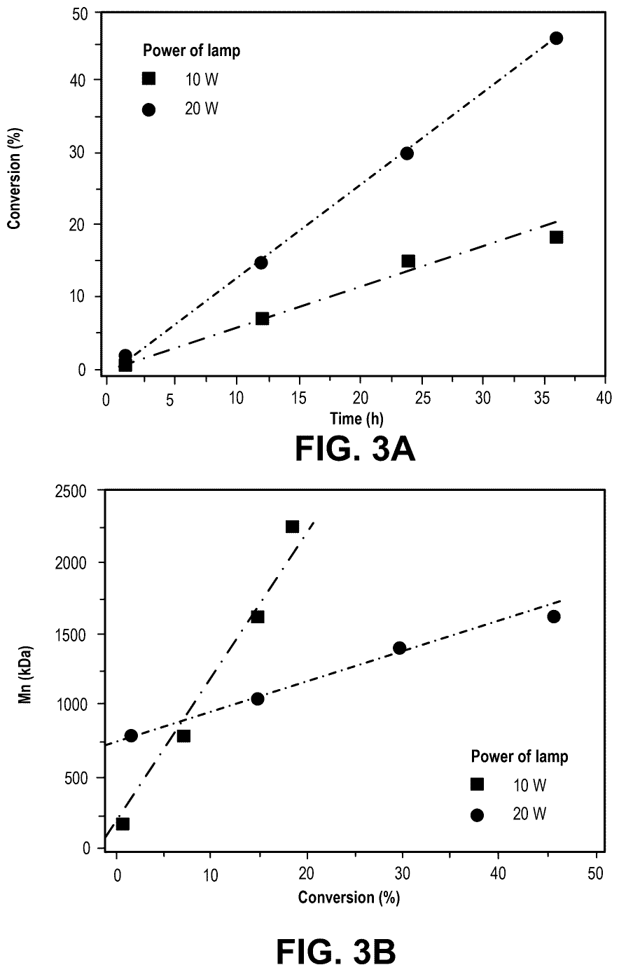

The polymerization rate may be significantly enhanced by employing a more powerful UV lamp, as shown in Table 2 and FIG. 3A and FIG. 3B, confirming the critical role of the UV excitation. It is believed that the polymerization can also be triggered thermally, but only ˜4% of conversion was achieved even after 36 hours, again, emphasizing the essential role of UV irradiation. To further understand the effect of temperature on the polymerization process, temporal control was implemented using a pulsed irradiation sequence under varied heating conditions. This method allowed for the modulation of the polymerization rate based on the interplay between light exposure and temperature as shown in FIG. 2C and Table 3. During periods devoid of light (12 hours) at 100° C., a reduced conversion was observed, which could be enhanced by raising the temperature (e.g. to 120° C.), indicating the presence of a thermally driven mechanism that complements the primary photochemical pathway. Notably, at a lower temperature of 70° C., polymerization predominantly occurs via the photo pathway, underscoring the potential to construct polymers with designed topological structures.

As illustrated in FIG. 3, the polymer conversions triggered by the 20 W lamp are nearly double those of the 10 W lamp at each polymerization time point. (B) presents plots of conversion versus molecular weight (Mn) for PME-Et homopolymers from different pots using two different UV lamp powers (10 W in square and 20 W in round), as detailed in Tables 1 and 2 herein. An almost linear increase in polymer Mn throughout the course of polymerization is observed for both lamps. However, the higher y-intercept of the Mn versus conversion plot and the relatively flatter increase in Mn suggest that the concentration of radicals is mainly controlled by the lamp at the initial stage. A stronger lamp can drive faster generation of radicals (biradicals here), offering more chains and leading to a lower Mn increase but higher conversion.

Table 2 presents details of PMBP for ME-Et initiated by different lamp with a feeding amount of 1 g at 100° C. The conversion trends from different powers of lamp suggests the light intensity can facilize the polymerization rate. And heat only can also trigger polymerization, but the conversion is low compared with that of PMBP method.

TABLE 2

| Run | UV lamp (W) | Time (h) | Conv. (%)^{a} | Mₙ (kDa)^{b} | Ð^{b} |
|---|---|---|---|---|---|
| 19 | 10 | 36 | 18.6 | 2246 | 1.78 |
| 20 | 20 | 1 | 1.2 | 798 | 2.58 |
| 21 | 20 | 12 | 14.9 | 1050 | 2.02 |
| 22 | 20 | 24 | 30.0 | 1406 | 1.88 |
| 23 | 20 | 36 | 45.8 | 1643 | 1.75 |
| 24 | NA^{c} | 12 | 1.9 | — | — |
| 25 | NA^{c} | 24 | 2.4 | — | — |
| 26 | NA^{c} | 36 | 4.2 | — | — |

^{a}Determined using the NMR spectra [400/500 Hz, r.t.];
^{b}Determined using the SEC data.
^{c}NA means no UV lamp was employed.

The details of PMBP for ME-Et are initiated by different lamp with a feeding amount of 1 g at 100° C. The conversion trends from different powers of lamp suggests the light intensity can facilize the polymerization rate. And heat only can also trigger polymerization, but the conversion is low compared with that of PMBP method.

Table 3 presents details of PMBP of ME-Et with temporal control of pulsed irradiation and varied thermal conditions. The UV lamp power was 10 W.

TABLE 3

| | Step 1: UV on | | Step 2: UV off | | Step 3: UV on | | |
|---|---|---|---|---|---|---|---|
| Run | Temp. (° C.) | Time (h) | Temp. (° C.) | Time (h) | Temp. (° C.) | Time (h) | Conv. (%) |
| 27 | 100 | 12 | 70 | 12 | — | — | 7.27 |
| 28 | 100 | 12 | 70 | 12 | 70 | 12 | 10.20 |
| 29 | 100 | 12 | 100 | 12 | — | — | 8.20 |
| 30 | 100 | 12 | 100 | 12 | 100 | 12 | 13.42 |
| 31 | 100 | 12 | 120 | 12 | — | — | 12.96 |
| 32 | 100 | 12 | 120 | 12 | 120 | 12 | 27.74 |

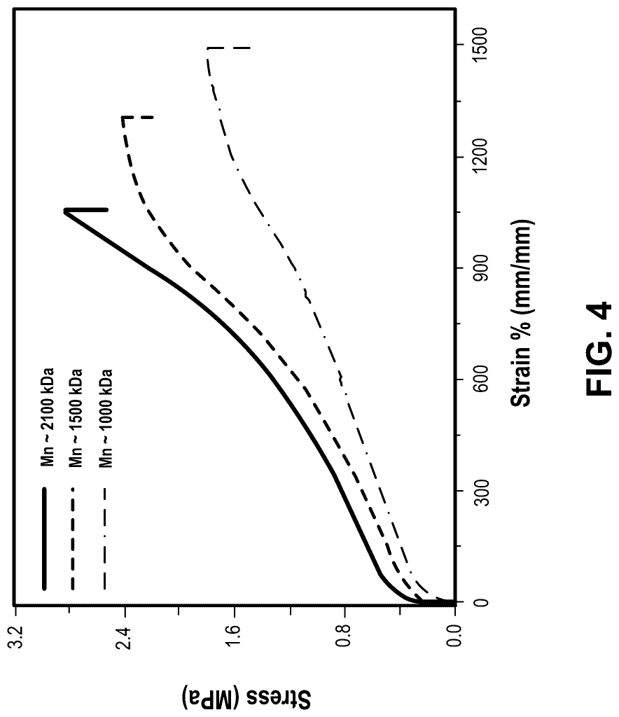

The PMBP method offers a straightforward approach for synthesizing ultrahigh molecular weight polymers with relatively uniform chain lengths (Mn˜2100 kDa, D˜1.5) as shown in FIG. 2D, and almost ultra-clean configuration, as shown in FIG. 2E, far surpassing the capabilities of previously reported polymerization methods. For instance, PME-Et, grained from the instantly demonstrated free radical polymerization in solution, as shown in Table 4, performs much lower molecular weight and larger dispersity with ˜2% of 1,2-addition, while almost pure configuration (˜100% of 1,4-addition including 2% of cis configuration) exists in the polymer chains from PMBP method. As expected, PME-Et with higher molecular weight possesses superior strength (P. J. Flory, J Am Chem Soc 67, 2048-2050 (1945) and M. Kojima, ACS Macro Lett 12, 1403-1408 (2023)), and the typical elastomer performance (˜2.9 MPa at 1060% strain) is achieved by increasing molecular weight via PMBP easily as shown in FIG. 4. Additionally, a tenfold scale-up of ME-Et polymerization was successfully achieved using PMBP, as shown in Table 5, indicating its practical applicability.

Table 4 presents details of PMBP for ME-Et initiated AIBN in 1,4-dioxane with a feeding amount of 10 g at 100° C. for 36 hours.

TABLE 4

| Run | ME-Et (eq.) | AIBN (eq.) | 1,4-dioxane (mL) | Conv. (%)^{a} | Mₙ (kDa)^{b} | Ð^{b} |
|---|---|---|---|---|---|---|
| 33 | 1000 | 1 | 6 | 28.1 | 46.7 | 2.75 |

^{a}Determined using ¹H NMR;
^{b}Determined using the SEC date.

Table 5 presents details of PMBP for ME-Et initiated by different lamp with a feeding amount of 10 g at 100° C.

TABLE 5

| Run | UV lamp (W) | Time (h) | Yield (%)^{a} | Mₙ (kDa)^{b} | Ð^{b} |
|---|---|---|---|---|---|
| 34 | 10 | 36 | 20.4 | 2126 | 1.52 |
| 35 | 20 | 36 | 42.9 | 1529 | 1.66 |
| 36 | 20 | 24 | 28.1 | 982 | 1.84 |

^{a}Determined using real weight of purified polymers;
^{b}Determined using the SEC date.

The versatility of this method is further highlighted by its efficacy in polymerizing muconate esters with diverse substituents, where polymerization temperatures are tailored according to their melting points to optimize outcomes (Table 6). The copolymerization capabilities of different muconate esters were also explored by combining ME-Bu and ME-Me in the same molar ratio (Table 7), which respectively possess the lowest and highest glass transition temperature (Tg) values. It was observed that a singlet SEC peak and a finely tuned moderate Tg from the DSC curve support the feasibility of synthesizing versatile random copolymers in a single reaction vessel via PMBP. This flexibility is pivotal for research and development endeavors, facilitating the exploration of novel copolymer compositions and properties with ease (C. W. FR Mayo, mayo-walling-2002-copolymerization. Chem Rev 46, 191-287 (1950)).

Table 6 presents details of PMBP for different ME-monomers with a feeding amount of 2 g for 36 h.

TABLE 6

| Run | Monomer (2 g) | Temp. (° C.)^{a} | Mₙ (kDa)^{b} | Ð^{b} | Conv. (%)^{c} | T_{g} (° C.) |
|---|---|---|---|---|---|---|
| 44 | ME-Bu | 100 | 827 | 1.71 | 32 | −30 |
| 45 | ME-Pr | 100 | 939 | 2.20 | 36 | −14 |
| 46 | ME-Et | 100 | 1236 | 1.82 | 40 | 7 |
| 47 | ME-Me (EZ)^{d} | 100 | 1716 | 1.73 | 29 | 64 |
| 48 | ME-B | 130 | 410 | 2.40 | 66 | 29 |
| 49 | ME-BOMe | 140 | 215 | 2.31 | 72 | 28 |

^{a}Set according to the melting point;
^{b}Determined using the SEC date;
^{c}Determined using the NMR spectra;
^{d}EZ-isomer was used for ME-Me since the EE-isomer is sublimated instead of melted while EE configuration was chosen for others, even though, some amount of sublimated ME-Me can be observed.

Table 7 presents details of PMBP for PME-(Bu-co-Me) for 36 h at 100° C.

TABLE 7

| Run | ME-Bu (g) | ME-Me (g) | Mₙ (kDa)^{a} | Ð^{b} | Yield (%)^{b} | T_{g} (° C.) |
|---|---|---|---|---|---|---|
| 50 | 1 | 1.2 | 802 | 1.85 | 32 | 4.1 |

^{a}Determined using the SEC date;
^{b}Determined using the real mass.

### Example 3—Reaction Mechanisms

Free radical polymerization of ME-Et with conventional azobisisobutyronitrile (AIBN) as an initiator in bulk was carried out. Typical polymerization behavior was observed, where monomer conversion plateaus around 10% due to significant termination reactions and the final molecular weights are low (Table 8). The dispersity of FRP increases with conversion, ultimately leading to a large dispersity of ˜4. PMBP strategy distinctly differs from conventional FRP by demonstrating a linear relationship between monomer conversion and molecular weight, as well as excellent molecular weight control. These results indicate that the concentration of the active species in the instant PMBP is likely constant, akin to the controlled/living polymerizations (K. Matyjaszewski, Nature Reviews Chemistry 5, 859-869 (2021); N. Hadjichristidis, Chem Rev 101, 3747-3792 (2001); and M. Uchiyama, Nature Chemistry 2024, 1-8 (2024), each of which is incorporated herein by reference). In conventional living polymerization, a constant concentration of active and dormant species endows dynamic reversible activation/deactivation. However, in the photo-melt-bulk polymerization, the biradical monomers can be generated continuously under UV irradiation, which is confirmed by the lack of suppression of polymerization even with 0.2% (mol/mol) of 2-methylbenzene-1,4-diol as an inhibitor (Table 9). Meanwhile, fortunately, the chain-chain coupling event can effectively reduce the number of free radicals. Consequently, a self-regulating mechanism of free radical concentration exists in PMBP via a subtle balance between generating and consuming the radical species, as illustrated in FIG. 1C-FIG. 1E.

Table 8 presents details of bulk polymerization for ME-Et initiated by AIBN (ME-Et:AIBN=1000:1) with a feeding amount of 1 g of ME-Et at 100° C.

TABLE 8

| Run | Time (h) | Conv. (%)^{a} | Mn (kDa)^{b} | PDI^{b} |
|---|---|---|---|---|
| 33 | 0.5 | 5.4 | 63 | 1.8 |
| 34 | 1 | 10.2 | 78 | 2.2 |
| 35 | 1.5 | 11.7 | — | — |
| 36 | 2 | 13.1 | 92 | 1.9 |
| 37 | 4 | 14.8 | 138 | 4.06 |
| 38 | 6 | 15.5 | — | — |

^{a}Determined using ¹H NMR;
^{b}Determined using the SEC date.

Table 9 presents details of PMBP for ME-Et in the presence of an inhibitor, using a feed amount of 1 g of ME-Et at 100° C. for 36 hours via the PMBP method. The UV lamp power was 10 W.

TABLE 9

| Run | ME-Et (eq.) | Inhibitor (eq.) | Temp. (° C.) | Conv. (%)^{a} |
|---|---|---|---|---|
| 39 | 1000 | 2 | 100 | 28 |

^{a}Determined using ¹H NMR.

The apparent linear growth kinetics may stem from the fact that the reaction features the combination of two classic polymerization mechanisms: on one hand, the reaction is similar to conventional chain polymerization with fast chain growth and slow monomer conversion due to the radical characteristics; but on the other hand, the chain-chain coupling process connect shorter chains into longer chains and keeps the active sites alive, similar to step polymerization (featuring fast monomer conversion and exponential chain length growth). The subtle balance of these two characteristics in one reaction eventually leads to a controllable and “living-like” polymerization kinetics. It is believed, this mechanism is quite unique and has not been extensively demonstrated in the literature. Built upon this understanding, a detailed reaction mechanism is proposed. Based on this mechanism, the rate equation was derived to be

$${R}_{p} = {\frac{{k}_{p} {k}_{e} {k}_{1}}{{k}_{r}} [ h v ] [ A ]}^{2} + {k}_{p}^{′} {\sqrt{{k}_{2}} [ A ]}^{2}$$

where Rp is propagation rate combining both photo irradiation and heating, k, k′, [hv], and [A] represent rate constant driven by photo irradiation, rate constant driven by heating, UV lamp intensity, and monomer concentration, respectively, and subscripts of p, e, and r are propagation, excitation, and relaxation, respectively. k1 and k2 are other rate constants.

The confined generation of biradicals and their preference for the coupling mechanism are further verified by density functional theory (DFT), using both the ME-Me monomer and an unsubstituted model compound of the butadiene monomer core as simple references as appropriate. In FIG. 2G, the singlet excited state (Si) and the triplet excited state (To) of an ME-Me monomer show highly similar molecular orbital arrangements, verifying the first excitation state accessed via photo irradiation contains a double radical along the butadiene backbone. The 3-fold difference in Mulliken spin density at C₃ vs C₄ in the triplet excited state suggests these radicals are more likely to be localized in positions at the outermost carbons of the butadiene, separated by a double bond, instead of being adjacent at the innermost carbons. This localization preference also provides indirect evidence for a 1,4-addition mechanism. This finding supports evidence of exceptionally clean reactions generating polymers with immaculate conformation (pure 1,4-addition) from ¹³C NMR spectra comparing PMBP with traditional FRP as shown in FIG. 2H. The triplet excited state also displays a partially elongated C₃-C₄ bond of 1.45 Å. This was hypothesized to indicate that photoexcitation places the ME-Me monomer into a de-facto geometric transition state that will highly favor spontaneous and fast addition to another monomer or a live chain end. To verify this, analysis of the reaction between an unexcited model compound monomer and a model living radical polymer end was completed. By discovering the transition state for the reaction and characterizing an approximation of the relative free energy change in the system, the intrinsic reaction coordinate defined by the C₃-C₄ bond of the monomer for the thermal pathway was determined. It was discovered that the transition state C₃-C₄ bond is about 1.37 Å and that by the time the bond has elongated to 1.45 Å, the system has already passed the transition state and is descending into the more favorable product free energy well. Furthermore, a single-point energy calculation of a photoexcited model monomer and a model living radical polymer end returned a system energy significantly higher than even the transition state of the model thermal pathway and a C₃-C₄ bond length of 1.45 Å. This not only suggests that the photoexcited system is highly thermodynamically driven towards reaction, but that the photoexcitation process places the monomer into a geometric arrangement more advanced along the polymerization reaction than even the transition state that again leads towards a reaction with little obstruction in the way of geometric rearrangement. Taken altogether, this provides evidence that the thermal and photoexcitation pathways can coexist, but that successful photoexcitation more quickly places the monomer into an advanced state along the reaction pathway that favors fast and exothermic coupling. While the amount of energy required to reach the photoexcited transition state is greater, any increased efficiency of the energy supplied by light relative to batch system heating will result in increased overall thermodynamic polymerization efficiency.

### Copolymerization, Depolymerization, and Applications

The PMBP method enables the synthesis of polymers with diverse topologies in a one pot, leveraging the synergy of photo and thermal activation and long-living radicals. This approach eliminates the need for complex purification steps. As shown in FIG. 3A, pure polystyrene (PS) segments may be constructed onto PME chains by holding the temperature at 70° C. and turning off the UV light. This results in the formation of triblock copolymers with potential applications as thermoplastic elastomers (TPEs). Additionally, continuing UV irradiation after adding styrene and acrylonitrile (AN) allows for the synthesis of random ternary copolymers that are suitable for plastic area.

### Example 4—Tri-Block Copolymer Synthesis

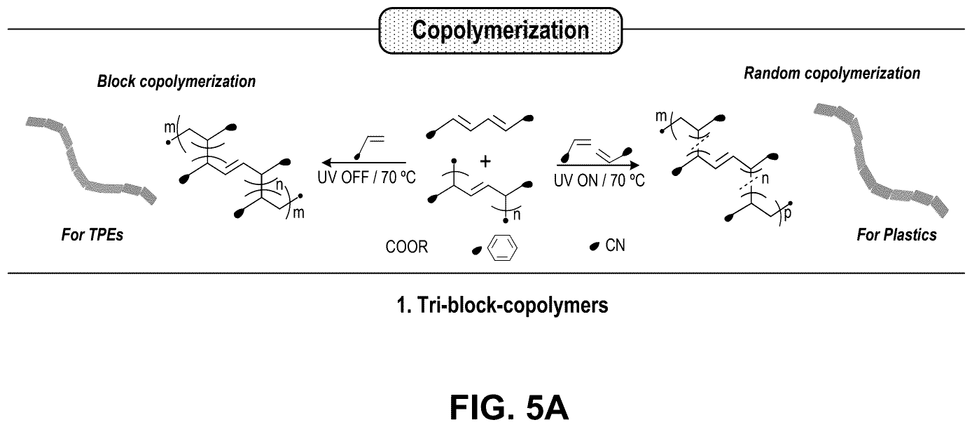

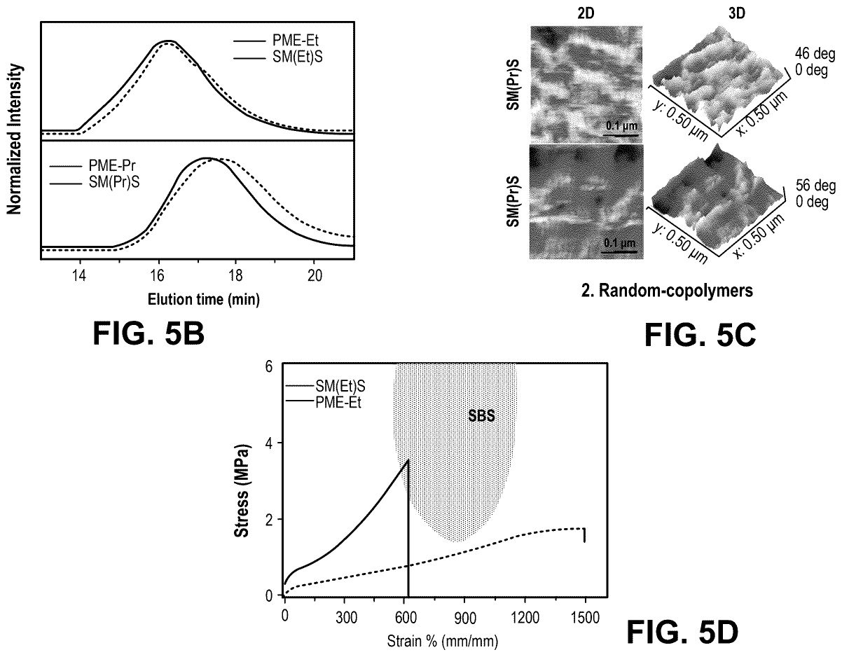

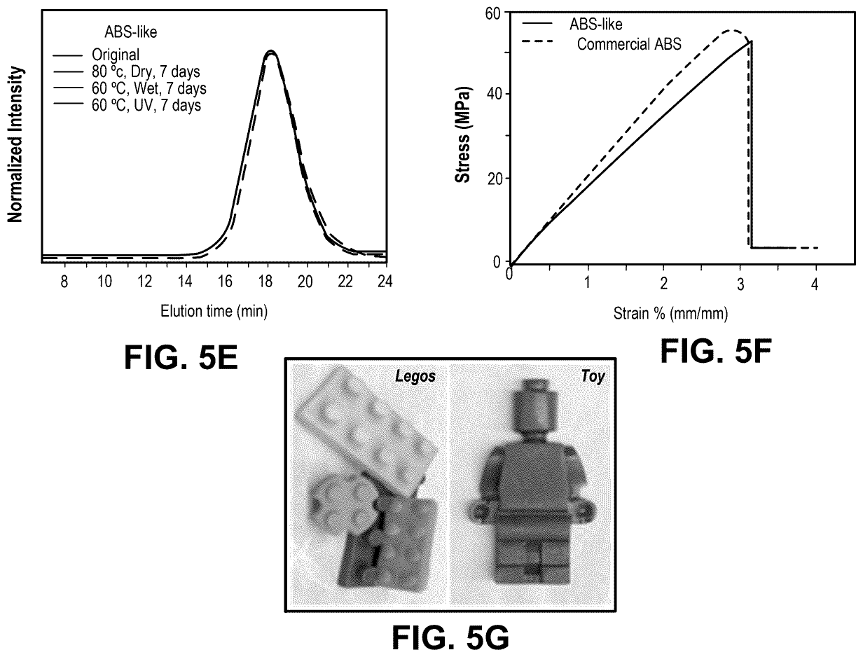

For tri-block copolymer synthesis, styrene is introduced to the PMBP pot after 20 hours, followed by turning off the UV light. Chain extension polymerization is confirmed by the progressive shift of SEC peaks towards higher molecular weights, indicating the reactivity of biradicals at the PME chain termini as shown in FIG. 5B. 1H NMR spectra reveal that constant UV exposure leads to random copolymerization, highlighting the importance of controlled UV exposure to achieve uniform PS segment growth. Interestingly, chain extension is successful even after storing PME-Et polymerization crude in the dark for one week without purification, showcasing the living-like character of radicals in PMBP.

The synthesized copolymers are ideal for developing TPEs, which combine the processing and recycling ease of thermoplastics with the elastic properties of thermoset rubbers. The elastomeric properties are provided by the soft PME-Et segments (low Tg), while the hard PS blocks (high Tg) form physical cross-links, providing strength and facilitating elastic recovery. DSC analysis reveals two Tg, confirming the block copolymer structure (U. Kalita, Macromolecules 54, 1478-1488 (2021) and J. Hintermeyer, Macromolecules 41, 9335-9344 (2008), each of which is incorporated herein by reference). Atomic Force Microscopy (AFM, FIG. 5C) and Grazing Incidence Wide-Angle X-ray Scattering (GIWAXS) studies show microphase-separated lamellae-like morphology and short-range order packing, respectively, indicating nanocrystal domains and physical crosslink points (R. D. Barent, Macromolecules 56, 5792-5802 (2023) and P. Busch, Macromolecules 40, 81-89 (2007), each of which is incorporated herein by reference). Mechanical testing, shown in FIG. 5D, of PME-based triblock copolymers shows thermoplastic elastomeric behavior, with SM(Et)S exhibiting a tensile strength of approximately 3.5 MPa and an elongation at break of 615%, comparable to commercial SBS TPEs.

The synthetic strategy is also applicable to random tri-copolymers. Acrylonitrile butadiene styrene (ABS) is valued for its robust mechanical properties. In this study, ME-Et replaces the traditional butadiene component to explore muconate esters as viable bio-based alternatives. The resulting ABS-like plastic, composed of 60.6% styrene, 30.3% ME-Et, and 9.1% acrylonitrile (AN), demonstrates a suitable Tg of approximately 83° C. for practical applications. The polymer's stability is confirmed by SEC after accelerated aging tests simulating extreme environmental conditions, as shown in FIG. 5E, showing no significant degradation.

The synthesized ABS-like polymer exhibits impressive mechanical properties, with a high break stress of 52 MPa and an elongation at break of 31%, comparable to commercial ABS is shown in FIG. 5F. This high break stress suggests suitability for structural applications. The polymer's adaptability to manufacturing processes was tested in the toy industry, demonstrating the ability to be dyed and molded with precision as shown in FIG. 5G. The dyed ABS-like plastic exhibited excellent color stability, with no visible fading after one month of outdoor exposure, which demonstrates the material's robust UV resistance and durability in outdoor conditions. Mechanical stress tests on toys made from this material confirmed their robustness, highlighting the potential of muconate esters to replace butadiene in ABS production and enhance the sustainability of plastic manufacturing.

### Example 5—Depolymerization and Chemical Recycling

Closed-loop recycling (CLR) involves breaking down polymers into monomers and repolymerizing them to promote a circular economy (G. W. Coates, Nature Reviews Materials 5, 501-516 (2020) and Y. Liu, Green Chemistry 24, 5691-5708 (2022), each of which is incorporated herein by reference). Challenges remain for all-carbon chain polymers (S. Kaiho, Macromolecules 55, 10628-10639 (2022); J. B. Zhu, Science 360, 398-403 (2018); B. A. Abel, Science 373, 783-789 (2021); W. Xiong, Chem 6, 1831-1843 (2020); J. B. Young, R. W. Chem 9, 2669-2682 (2023); M. R. Martinez, Macromolecules 55, 10590-10599 (2022); and G. R. Jones, J Am Chem Soc 145, 9898-9915 (2023), each of which is incorporated herein by reference). Studies (X. Luo, J Am Chem Soc 144, 16588-16597 (2022) and L. Dou, Science 343, 272-277 (2014), each of which is incorporated herein by reference) show that the elongated C—C bonds are correlated with reduced bond dissociation energies, facilitating depolymerization. Thermal analysis and initial attempts indicate such possibility is still maintained in PMEs from PMBP.

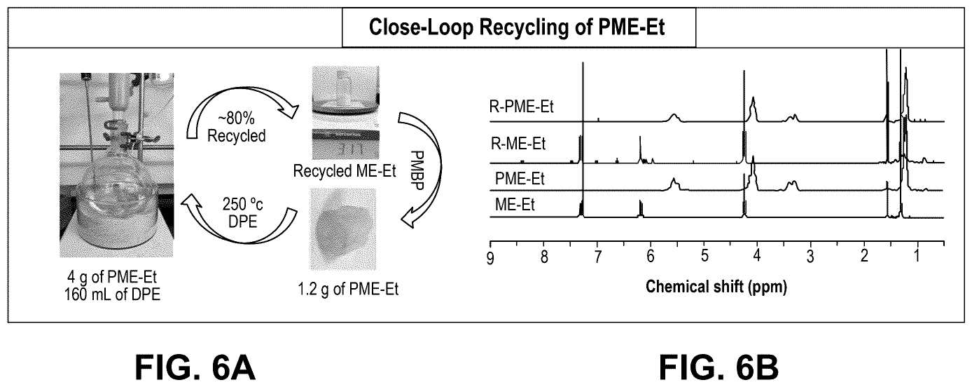

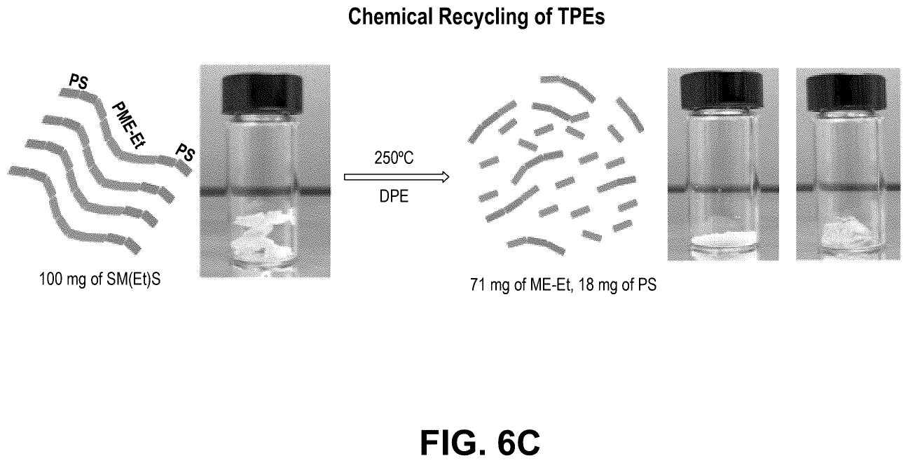

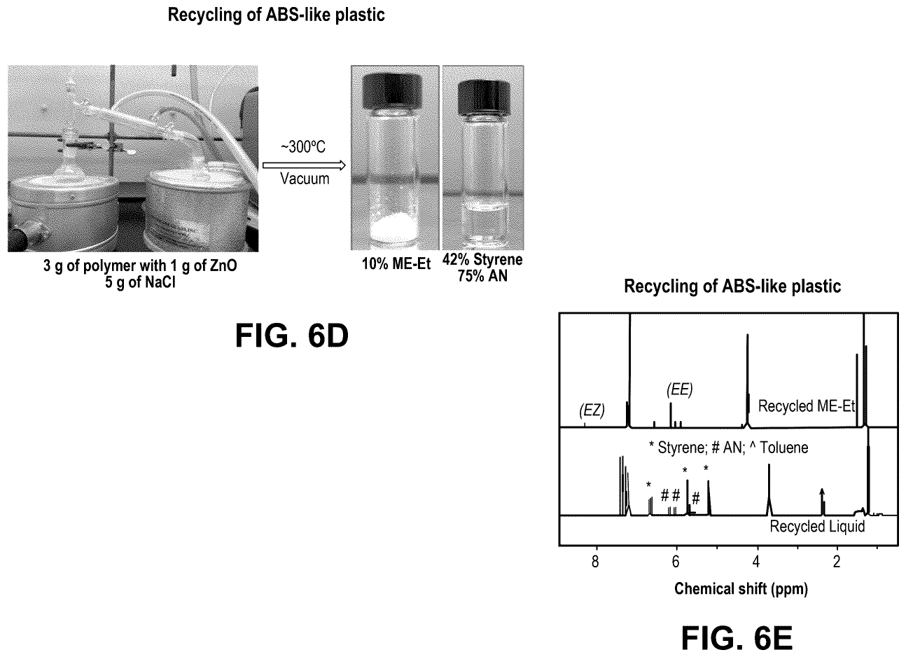

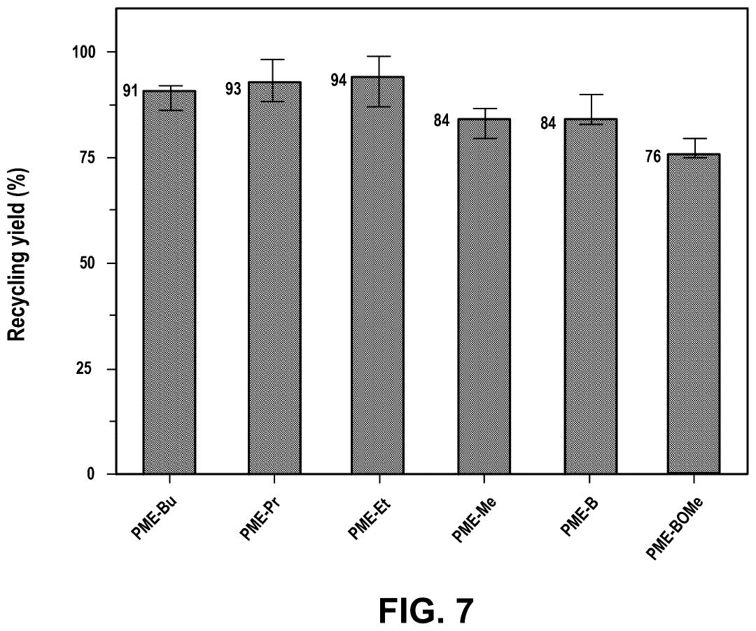

Using dilute diphenyl ether (DPE), ˜92% of ME-Et monomer was recovered at 250° C., and ˜80% was recovered on scaling up concentrated condition as shown in FIG. 6A. The recovered monomers can be further polymerized via PMBP as shown in FIG. 6B. Other PMEs with different substituents also showed high recovery rates ads shown in FIG. 7.

Significant advancements have been made in recycling TPEs back to their monomers (U. Kalita, Macromolecules 54, 1478-1488 (2021) and G. L. Gregory, Angewandte Chemie International Edition 61, e202210748 (2022), each of which is incorporated herein by reference). However, recycling widely used TPEs such as styrene-butadiene-styrene (SBS) is challenging due to high ceiling temperatures. Here, the feasibility of chemically recycling the instant MEs-based TPEs was investigated. By heating at 250° C. in diphenyl ether (DPE) for one hour, successful recovery of approximately 71 mg (˜86%) of ME-Et from 100 mg of SM(Et)S and 74 mg (˜89%) of ME-Pr from 100 mg of SM(Pr)S was achieved. Additionally, PMEs armed with recycled polystyrene (R-PS) segments without detectable depolymerization of the PS parts were obtained. The foam-like state of R-PS after solvent removal suggests potential applications for expanded polystyrene as shown in FIG. 6C.

Chemical recycling of ABS is urgent but underreported (Y. Miao, Polymers 13, 449 (2021) and S. Kim, Sci Adv 8, 6006 (2022), each of which is incorporated herein by reference) Depolymerizing ABS-like plastic with PME-Et segments was explored. DSC profiles indicated heat flow fluctuations after 300° C., suggesting gas emission during depolymerization. When attempting depolymerization around 300° C. without additives, some liquid products were obtained, while no products were collected from commercial ABS plastic. The determination was made using ¹H NMR spectra. Reaction conditions for the temporal control polymerization were UV on/100° C./12 h_UV off/120° C./12 h or UV on/100° C./12 h_UV off/120° C./12 h_UV on/120° C./12 h.

Interestingly, ZnO powder reduced the depolymerization temperature to 270° C. and increased liquid product yield, confirming its catalytic effect. Adding NaCl to the setup improved purity, yielding 10% ME-Et, 42% styrene, 75% acrylonitrile recovery as shown in FIG. 6D and FIG. 6E. Note, 4% toluene and a little amount of ethylbenzene, and 2-phenyl-1-propene was obtained, consistent with the previous reports about depolymerization and degradation of PS (V. KumarAjmir, ACS Sustainable Chem. Eng. 10, 6493-6502 (2022) and C. Marquez, Mater. Horiz. 10, 1625-1640 (2023), each of which is incorporated herein by reference). Interestingly, the presence of ME units in random copolymer chains weakens nearby C—C bonds, enabling efficient depolymerization and recovery of conventional olefin units such as styrene and acrylonitrile. Further investigation is needed to improve recycled monomer purity and yield, but the instant proof-of-concept demonstrates the potential for efficient chemical recycling of these materials. All the PMEs, TPEs, and ABS-like polymer deliver good monomer recovery yield, forwarding a recyclable polydiene-based material world. The determination was made using ¹H NMR spectra. Reaction conditions for the temporal control polymerization were UV on/100° C./12 h_UV off/70° C./12 h or UV on/100° C./12 h_UV off/70° C./12 h_UV on/70° C./12 h.

### Example 6—Polymer Synthesis

### Polymerization of Trans,Trans-Diethyl Muconate (PME-Et) for Kinetic Study

1 g of diethyl muconate ester (ME-Et, 5 mmol) was charged in a 25 mL round-bottom flask with a stir bar, and the whole system was charged to Argon by three times of pump-Ar procedure. Then the flask was placed into a 100° C. of oil bath until all the monomer was melted. A UV lamp (UVA range) was equipped, and the temperature was kept for a certain hour (3 separated pots for each polymerization time). After polymerization, 8 mL of CHCl₃ was added to dissolve the crude products and a drop of the solution was taken for crude NMR measurement. For the purification, the remaining solution was poured into 200 mL of hexanes and the precipitates were washed by CHCl₃/Hexanes for several times until there is no monomer can be detected by TLC. The hexanes soluble part was collected, and solvents were removed by vacuum rotary evaporator, the gained white powder was gone through flash silica column with CH₂Cl₂ as elution to get unreacted monomer back. The white hexanes insoluble polymer was dried in vacuum oven and went to the molecular weight analysis via SEC.

### Polymerization of Different MEs (PMEs)

The polymerization method of other MEs is similar with the one for PME-Et, where the polymerization temperature is 100° C. for ME-Bu, ME-Pr, and ME-Me, while 125° C. was chosen for ME-B and 135° C. for ME-BOMe based on their melting points. After polymerization, 8 mL of CHCl3 was added to dissolve the crude products and a drop of the solution was taken for crude NMR measurement. For the purification, the remaining solution was poured into 200 mL of hexanes and the precipitates were washed by CHCl3/Hexanes for several times until there is no monomer can be detected by TLC. The hexanes soluble part was collected, and solvents were removed by vacuum rotary evaporator, the gained white powder was gone through flash silica column with CH₂Cl₂ as elution to get unreacted monomer back. The white hexanes insoluble polymer was dried in vacuum oven and went to the molecular weight analysis via SEC.

### Polymerization of Different MEs (PMEs)

The polymerization and purification procedure are similar with above ones. 1 g of ME-Bu and 1 g of ME-Me were fed in flask initially and placed in an oil bath set a temperature as 100° C. for 36 hours with UV irradiation of 20 W constantly. After purification, 0.89 g of copolymer can be gained with a yield of 44.5%.

### Example 7—Depolymerization and Chemical Recycling

### Depolymerization of Homopolymer PMEs in DPE

100 mg of PMEs was dissolved in 10 mL of diphenyl ether (DPE) in a round bottom flask, then change the atmosphere to Argon for 3 times of pumping-Ar step and put into a pre-heated sand bath (250° C.) under Ar for 1 hours. Finally, the depolymerization crude solutions were separated by flash silica gel column, and first DPE was separated by hexanes, and recycled monomers were collected by DCM following. Then the recovered DPE and monomers were gained after removing the solvents.

### Depolymerization of TPEs

100 mg of SEtS or SPrS was dissolved in 10 mL of diphenyl ether (DPE) in a round bottom flask, then change the atmosphere to Argon for 3 times of pumping-Ar step and put into a pre-heated sand bath (250° C.) under Ar for 1 hours. Finally, the depolymerization crude solutions were poured into hexanes to get polymer residues (R-PS), and the hexanes-soluble parts were separated by flash silica gel column, and first DPE was separated by hexanes, and recycled ME monomers were collected by DCM following. Then the recovered DPE and monomers were gained after removing the solvents.

### Depolymerization of ABS-Like Plastics

Around 3 g of ABS-like plastic was cut to small pieces and put into a ground bottom flask with/without ZnO powder. The atmosphere in the flask was changed to argon three times and kept in vacuum finally. The heated flask was linked to a condenser and the collection flask was immersed in liquid N₂. Then put into a pre-heated (˜300° C.) sand bath for a certain time. The distilled monomers with byproducts were collected in a small flask in Liquid N₂. The recovered ME-Et monomers were further purified by silica gel column from the hexanes-soluble part of the depolymerization flask by DCM and hexanes.

### Example 8—Constant Generation of Biradical Via PMBP Method

### Kinetics Study of ME-Et Via PMBP (10 W)

1 g of diethyl muconate ester (ME-Et, 5 mmol) and 0.2% (mol/mol) of 2-methylbenzene-1,4-diol as an inhibitor were placed in a 25 mL round-bottom flask equipped with a stir bar. The system was purged with argon using a three-cycle pump-argon procedure. The flask was then placed in a 100° C. oil bath until all the monomers had melted. A UV lamp (UVA range) was equipped, and the temperature was maintained for 36 hours. After polymerization, 8 mL of CHCl₃ was added to dissolve the crude products, and a drop of the solution was taken for crude NMR and SEC measurement.

Table 10 presents details of PMBP for ME-Et in the presence of an inhibitor, using a feed amount of 1 g of ME-Et at 100° C. for 36 hours via the PMBP method (10 W).

TABLE 10

| Run | ME-Et (eq.) | Inhibitor (eq.) | Temp. (° C.) | Conv. (%)^{a} |
|---|---|---|---|---|
| 39 | 1000 | 2 | 100 | 28 |

^{a}Determined using ¹H NMR.

The self-regulating mechanism of radical concentration in this strategy is validated through time-dependent electron paramagnetic resonance (EPR) spectra. In both cases of 10 W and 20 W lamps, taking the data at 1 hour as reference, it shows that the radical concentration remains within a certain range and stabilizes after an initial decline, indicating dynamic regulation of radical concentration works as the polymerization medium species. Radicals generated from the irradiation reimburse the radical counteraction caused by coupling reaction. It was observed that the radical triggered by 20 W lamp is more concentrated than that of 10 W lamp after 1 hour, indicating the positive relationship between UV intensity (hv) and polymerization rate. The stability of the biradical was further examined via EPR by monitoring the radical concentration change of PMBP crude after polymerized for 20 hours. As presented in FIG. 2F, there are still 92.1% of radicals remaining after the crude kept at room temperature under dark for 10 days, suggesting the surprisingly long-lived ultra-stable biradical in PMBP.

### Example 9—Polymerization of TPEs (SM(Et)S)

1 g of diethyl muconate ester (ME-Et, 5 mmol) was charged in a 25 mL round-bottom flask with a stir bar, and the whole system was charged to Argon by three times of pump-Ar procedure. Then the flask was placed into a 100° C. of oil bath until all the monomer was melted. A UV lamp (UVA range) was equipped, and the temperature was kept for 20 hours. After polymerization, the temperature was decreased to 70° C. and 10 mL of styrene was injected into the flask. Keeping the temperature and darked the reaction for 8 hours. After polymerization, the block copolymer was purified by hexanes several times to get white polymer with a weight of 325.2 mg. the prepared triblock copolymer was named as SM(Et)S. The compared experiment with constant UV irradiation was conducted with similar procedure, and the final product was named as ran-SM(Et)S.

### Example 10—Chain Extension of PME-Et after Keeping for 1 Week at Dark

1 g of ME-Et in flask was polymerized at 100° C. by PMBP for 20 hours by UV lamp of 20 W, and then stored under dark at room temperature (r.t.) for 1 week. Then 10 mL of styrene was added to 1) at 70° C., the crude in 1) was totally dissolved in styrene within a half hour and after 8 hours, a chain extension from SEC curves was observed.

### Example 11—Experimental Process for TPEs (SM(Pr)S)

1 g of dipropyl muconate ester (ME-Pr, 4.9 mmol) was charged in a 25 mL round-bottom flask with a stir bar, and the whole system was charged to Argon by three times of pump-Ar procedure. Then the flask was placed into a 100° C. of oil bath until all the monomer was melted. A UV lamp (UVA range) was equipped, and the temperature was kept for 20 hours. After polymerization, the temperature was decreased to 70° C. and 10 mL of styrene was injected into the flask. Keeping the temperature and darked the reaction for 3 hours. After polymerization, the block copolymer was purified by hexanes several times to get white polymer with a weight of 296.1 mg.

### Example 12—Production of ABS-Like Plastic

8 g of diethyl muconate ester (ME-Et, 40 mmol) was charged in a 100 mL of round-bottom flask with a stir bar, and the whole system was charged to Argon by three times of pump-Ar procedure. Then the flask was placed into a 100° C. of oil bath until all the monomer was melted. A UV lamp (UVA range) was equipped, and the temperature was kept for 2 hours. Then, the temperature was decreased to 70° C. and 17 mL of styrene and 9 mL of AN were injected into the flask. Keeping the temperature and darked the reaction for certain hours. After polymerization, the block copolymer was purified by hexanes several times to get white polymer with a weight of 19.8 g.

### Example 13—Bulk Depolymerization of PME-Et Under Argon

100 mg of PME-Et was cut to small pieces and put into a ground bottom flask. The atmosphere in the flask was changed to argon three times, then put into a pre-heated (250° C.) sand bath for two hours. After depolymerization, 10 mL of hexanes was poured into the flask for three times to wash the recycled monomer and small by-product (32.5 mg) out, and the remaining dark brown oily residues were checked by ¹H NMR and SEC. After separation by silica gel column (CHCl₃ as eluent), only 12.5% of monomer can be recycled.

### Example 14—Bulk Depolymerization of PME-Et Under Vacuum

100 mg of PME-Et was cut to small pieces and put into a ground bottom flask. The atmosphere in the flask was changed to argon three times and kept vacuum finally, then put into a pre-heated (250° C.) sand bath for two hours. After depolymerization, 10 mL of hexanes was poured into the flask for three times to wash the recycled monomer and small byproduct (73.8 mg) out, and the remaining dark brown oily residues were checked by ¹H NMR and SEC. finally, the recycled monomer was gained by further purification through a flash silica column with CHCl₃ (68.4 mg), or the monomer can be collected from the wall of flask and trapper directly.

### Example 15—Solution Depolymerization (Dilute) of PME-Et in DPE Under Argon

50 mg of PME-Et was cut to small pieces and put into a ground bottom flask with 10 mL of DPE (diphenyl ether). The atmosphere in the flask was changed to argon three times and keep Argon finally, then put into a pre-heated (250/300° C.) sand bath for 60 min. After depolymerization, recycled monomer was separated through a flash column.

### Example 16—Solution Depolymerization (Concentrated) of PME-Et in DPE Under Argon

4 g of PME-Et was cut to small pieces and put into a ground bottom flask with 160 mL of DPE (diphenyl ether). The atmosphere in the flask was change to argon for three times and keep Argon finally, then put into a pre-heated (250° C.) sand bath for 100 min. After depolymerization, recycled monomer was separated through a flash column.

### Example 17—Repolymerization of Recycled ME-Et by PMBP

3 g of Recycled ME-Et was charged in a 25 mL round-bottom flask with a stir bar, and the whole system was charged to Argon by three times of pump-Ar procedure. Then the flask was placed into a 100° C. of oil bath until all the monomer was melted. A UV lamp (UVA range, 20 W) was equipped, and the temperature was kept for 36 hours. After polymerization, the repolymerized PME-Et was poured from Hexanes/CHCl₃ for several times.

### Example 18—Depolymerization of TPEs in DPE Under Argon

100 mg of SM(Et)S or SM(Pr)S was cut to small pieces and put into a ground bottom flask with 20 mL of DPE (diphenyl ether). The atmosphere in the flask was changed to argon three times and keep Argon finally, then put into a pre-heated (250° C.) sand bath for 60 min. After depolymerization, polystyrene residues were removed by hexanes, then, recycled monomer was separated through a flash column. Finally, 71 mg of ME-Et and 18 mg of PS segments were obtained for SM(Et)S, while 74 mg of ME-Pr and 16 mg of PS segments were obtained for SM(Pr)S.

### Example 19—Bulk Depolymerization of ABS-Like Plastics Under Vacuum

Around 3 g of ABS-like plastic was cut to small pieces and put into a ground bottom flask with 1.5 g of ZnO powder. The atmosphere in the flask was changed to argon three times and kept in vacuum finally. The heated flask was linked to a condenser and the collection flask was immersed in liquid N₂. Then put into a pre-heated (˜300° C.) sand bath for 60 min. the distilled monomers with byproducts were collected in the small flask in Liquid N₂. The collection was further purified by silica gel column three times.

### Example 20—Modified Bulk Depolymerization of ABS-Like Plastics Under Vacuum

Around 3.1 g of ABS-like plastic was cut to small pieces and put into a ground bottom flask with 1 g of Zink Oxide (ZnO) powder and 5 g of NaCl. The atmosphere in the flask was changed to argon three times and kept in vacuum finally. The heated flask was linked to a condenser and the collection flask was immersed in liquid N₂. Then put into a pre-heated (˜300° C.) sand bath for 4 hours, when there was no gas or babble emitted from the black residual. The distilled monomers with byproducts were collected in a small flask in Liquid N₂. All the wall of glassware and black residuals were washed with hexanes, and the ME-Et monomer was recycled and separated from the hexanes soluble part (˜15 mg after purification via silica gel column). The collected liquid part was gone through a very thin silica gel to remove the insoluble solid, like ZnO powders came with vacuum, finally 1.12 g of transparent liquid was gained.

This disclosure has delineated a transformative approach in polymer science through the development of the ultra-clean photo-melt-bulk polymerization (PMBP) technique for the synthesis of bio-based polydiene derivatives, particularly amorphous polymuconate esters. This method stands out by eliminating the need for solvents, catalysts, or initiators, thereby addressing significant environmental and technical limitations of conventional polymerization processes. The PMBP technique not only achieves high molecular weight polymers with controlled architectures, such as ABA tri-block polymers and random copolymers, but also enhances the sustainability of the polymer lifecycle. The instant results demonstrate the practical application of these polymers in various industries, from toys to advanced composites, indicating their robustness and adaptability. The ability of these materials to mimic the properties of widely used plastics, like ABS, underscores their potential to replace more environmentally damaging alternatives. Furthermore, the successful recycling of these materials into their original monomeric forms via an innovative depolymerization process highlights a significant step towards achieving true closed-loop recycling in polymer production. This process not only supports the principles of green chemistry but also contributes to the reduction of waste and reliance on non-renewable resources. Through this work, a new standard for the synthesis and recycling of polymers, contributing to the advancement of sustainable materials science and offering viable solutions for industry-wide challenges was obtained.

### Enumerated Embodiments (EE)

The following list of enumerated embodiments presents claims with multiply dependent claims depending from multiply dependent claims for presentation in those jurisdictions where such dependencies are allowed as well as additional claims, which may be presented during the examination of the application or any divisional or continuation thereof.

EE 1. A method of polymerizing a polydiene comprising:
(i) melting the diene to produce a melted diene; and
(ii) irradiating the melted diene with ultraviolet (UV) light to produce a polymer;
wherein the melting and irradiating are performed substantially in the absence of solvent or catalyst.

EE 2. The method of EE 1, wherein the diene is a muconate ester.

EE 3. The method of EE 2, wherein the muconate ester is a C₁-C₁₂ ester.

EE 4. The method of EE 2 or EE 3, wherein the muconate ester is a methyl, ethyl, propyl, or butyl ester.

EE 5. The method of any one of EEs 1-4, wherein the UV light is about 315 nm to about 400 nm.

EE 6. The method of EE 5, wherein the UV light is provided by a UV lamp having a power of about 1 W to about 1000 W.

EE 7. The method of any one of EEs 1-6, wherein the melting is performed in the absence of solvent.

EE 8. The method of any one of EEs 1-7, wherein the irradiating is performed in the absence of catalyst.

EE 9. The method of any one of EEs 1-8, wherein the melting and irradiating are performed in the absence of solvent and catalyst.

EE 10. The method of EE 2, wherein the muconate ester is formed by reacting muconic acid with a compound of the formula R—OH to form a dialkyl muconate, wherein R is C₁-C₁₂ alkyl.

EE 11. The method of EE 10, wherein the muconic acid is trans-trans muconic acid.

EE 12. The method of EE 10, wherein the muconic acid is trans-cis muconic acid.

EE 13. The method of any one of EEs 10-12, wherein the muconate ester is formed in the presence of sulfuric acid.

EE 14. The method of any one of EEs 10-13, wherein R is methyl, ethyl, propyl, or butyl.

EE 15 A method of producing a polymer comprising:
reacting muconic acid with a compound of the formula R—OH to form a dialkyl muconate, wherein R is C₁-C₁₂ alkyl;
irradiating the melted dialkyl muconate with ultraviolet (UV) light to produce a polymer; and
mixing styrene into the polymer in the absence of UV light to produce a triblock copolymer.

EE 16. The method of EE 15, wherein step (i) is performed in the presence of sulfuric acid.

EE 17. The method of EE 15 or EE 16, wherein R is methyl, ethyl, propyl, or butyl.

EE 18. The method of any one of EEs 15-17, wherein the melting and irradiating is performed in the absence of solvent and catalyst.

EE 19. The method of any one of EEs 15-18, wherein acrylonitrile is added with the styrene in step (iv).

EE 20. A method of depolymerizing a polymer made by a method according to any one of EEs 1-19, the method comprising heating the polymer to a temperature of from about 230° C. to about 340° C.

What is claimed:

1. A method of polymerizing a polydiene comprising
(i) melting a diene to produce a melted diene; and
(ii) irradiating the melted diene with ultraviolet (UV) light to produce a polymer;
wherein the melting and irradiating are performed substantially in the absence of solvent or catalyst.

2. The method of claim 1, wherein the diene is a muconate ester.

3. The method of claim 2, wherein the muconate ester is a C₁-C₁₂ ester.

4. The method of claim 2, wherein the muconate ester is a methyl, ethyl, propyl, or butyl ester.

5. The method of claim 1, wherein the UV light has a wavelength of about 315 nm to about 400 nm.

6. The method of claim 5, wherein the UV light is provided by a UV lamp having a power of about 1 W to about 1000 W.

7. The method of claim 1, wherein the melting is performed in the absence of solvent.

8. The method of claim 1, wherein the irradiating is performed in the absence of catalyst.

9. The method of claim 1, wherein the melting and irradiating are performed in the absence of solvent and catalyst.

10. The method of any one of claims 2-4, wherein the muconate ester is formed by reacting muconic acid with a compound of the formula R—OH to form a dialkyl muconate, wherein R is C₁-C₁₂ alkyl.

11. The method of claim 10, wherein the muconic acid is trans-trans muconic acid.

12. The method of claim 10, wherein the muconic acid is trans-cis muconic acid.

13. The method of claim 10, wherein the muconate ester is formed in the presence of sulfuric acid.

14. The method of claim 10, wherein R is methyl, ethyl, propyl, or butyl.

15. A method of producing a polymer comprising:
(i) reacting muconic acid with a compound of the formula R—OH to form a dialkyl muconate, wherein R is C₁-C₁₂ alkyl;
(ii) melting the dialkyl muconate to produce a neat liquid;
(iii) irradiating the melted dialkyl muconate with ultraviolet (UV) light to produce a polymer; and
(iv) mixing styrene into the polymer in the absence of UV light to produce a triblock copolymer.

16. The method of claim 15, wherein step (i) is performed in the presence of sulfuric acid.

17. The method of claim 15, wherein R is methyl, ethyl, propyl, or butyl.

18. The method of claim 15, wherein the melting and irradiating is performed in the absence of solvent or catalyst.

19. The method of claim 15, wherein acrylonitrile is added with the styrene in step (iv).

20. A method of depolymerizing a polymer made by a method according to any one of claims 15-19, the method comprising heating the polymer to a temperature of from about 230° C. to about 340° C.
